(19) United States
(12) Patent Application Publication
(10) Pub. No.: US 2004/0244542 A1
(43) Pub. Date: Dec. 9, 2004

(54) Stopper removing devices

(76) Inventor: Frank William Love, Derby (GB)

Correspondence Address: SMITH-HILL AND BEDELL, 12670 N W BARNES ROAD, SUITE 104, PORTLAND, OR, 97229

(21) Appl. No.: 10/491,837

(22) PCT Filed: Oct. 9, 2002
(86) PCT No.: PCT/GB02/04585

(30) Foreign Application Priority Data
Oct. 9, 2001 (GB) 0124196.7

(51) Int. Cl. B67B 7/18

(52) U.S. Cl. 81/3.29

(57) ABSTRACT

A stopper removing device for removing a stopper from a container or similar, such as a wine bottle, comprises a body, stopper means to engage a stopper to be removed and handle means on the body which are selectively engageable with the stopper means to enable selective movement of the stopper means therewith relative to the body and thereby removal of the stopper.

The present invention relates to stopper removing devices and particularly but not exclusively devices for removing stoppers, such as corks from bottles.

There are a number of known designs of devices for removing stoppers from bottles, in particular corkscrews for removing corks from wine bottles. These known devices suffer from the drawback that a screw or thread is driven into the cork and at times this can be driven straight through the length of the cork resulting in parts of the cork breaking off and contaminating the contents of the bottle.

According to the present invention there is provided a stopper removing device for removing a stopper from a container or similar, the device comprising a body, stopper means to engage a stopper to be removed and handle means on the body, the handle means being selectively engageable with the stopper means to enable selective movement of the stopper means therewith relative to the body.

Transmission means may be provided to transmit selective movement of the handle means to said movement of the stopper means. The transmission means is located between the handle means and stopper means and may be in co-operation with the stopper means, desirably permanently. The transmission means may be mounted on the body and preferably provides for transmission of generally pivotal movement of the handle means to substantially linear movement of the stopper means. The transmission means is preferably pivotally mounted on the body.

Preferably the handle means is mounted on the body and preferably pivotally mounted thereon. The handle means may be selectively moveable between a first condition in which the handle means is operably engaged with the transmission means and said selective movement of the handle means causes movement of the transmission means and a second condition in which the handle means is disengaged therefrom.

The handle means may comprise an engagement arrangement having an engagement member and resilient means to urge the engagement member away from operable engagement with the transmission means. The resilient means may comprise a spring to urge the engagement member, which member may be in the form of a locating pin. The handle means may comprise a moveable section selectively moveable against the resilient means to a first position wherein the engagement member is in engagement with the transmission means. The handle means is preferably further selectively moveable to a second position to allow the resilient means to urge the engagement member away from engagement with the transmission means. The moveable section may be movably attached, desirably pivotally, to a further section of the handle means on which the engagement arrangement is provided. The further section is preferably pivotally mounted on the body. Alternatively, the movable section may be slidably attached to a further section of the handle, the engagement arrangement being provided on the movable section. The further section is preferably pivotally mounted on the body and is desirably substantially located within the movable section to enable sliding movement of the movable section over the further section. The engagement member is desirably in the form of a locating pin provided on the movable section.

Preferably the transmission means comprises a wheel member rotatably attached to the body, which wheel member comprises an engagement formation co-operable with formations provided on the stopper means, whereby to provide rotational movement of the transmission means to cause generally linear movement of the stopper means. A plurality of engagement formations may be provided, which may comprise a series of teeth around the transmission means.

Preferably a series of holes or similar formations is provided around the transmission means, and desirably around an outer circumferential perimeter thereof, to individually receive the engagement member during use. The holes or similar formations are preferably equispaced around the transmission means. Alternatively, the engagement member may be received between the teeth around the transmission means during use.

Preferably the stopper means is located through and desirably generally within the body. The body may comprise locating means on one end thereof to locate against a container or other body from which stopper is to be removed. Preferably the stopper means comprises a stopper engaging portion which may be twistedly locatable into a stopper to be removed. Preferably stop means is provided to limit the distance the engaging portion can be inserted into a stopper.

Preferably the stopper means comprises a handle to facilitate twisting of the engaging means for location in the stopper. Preferably the said formations on the stopper means are located between the handle and the stopper engaging means.

The body may include cutting means to enable removal of protective packaging from a container or similar.

Preferably the body is generally cylindrical and includes a substantially frustoconical portion for location over a neck of a container or similar, the frustoconical portion including the cutting means. The cutting means desirably comprises an abrasive surface, which may comprise a layer of adhesive material and abrasive particles located therein. Alternatively, the cutting means may comprise one or more blades, preferably three blades, which are equispaced around an inner surface of the frustoconical portion.

Preferably a plurality and desirably a pair of transmission means and handle means is provided, to enable generally simultaneous actuation of transmission means to remove a stopper from a container.

According to a further aspect of the present invention, there is provided a stopper removing device for removing a stopper from a container or similar, the device comprising a body, stopper means to engage a stopper to be removed and handle means on the body, the body including cutting means to enable removal of protective packaging from a container or similar.

Preferably, the body has a substantially frustoconical portion for location over a neck of the container or similar. The substantially frustoconical portion may include the cutting means.

Preferably the cutting means comprises an abrasive surface, which may comprise a layer of adhesive material and abrasive particles located therein. Alternatively, the cutting means may comprise one or more blades, and desirably three blades which are equispaced around an inner surface of the frustoconical portion.

Embodiments of the present invention will now be described by way of example only, with reference to the accompanying drawings in which:

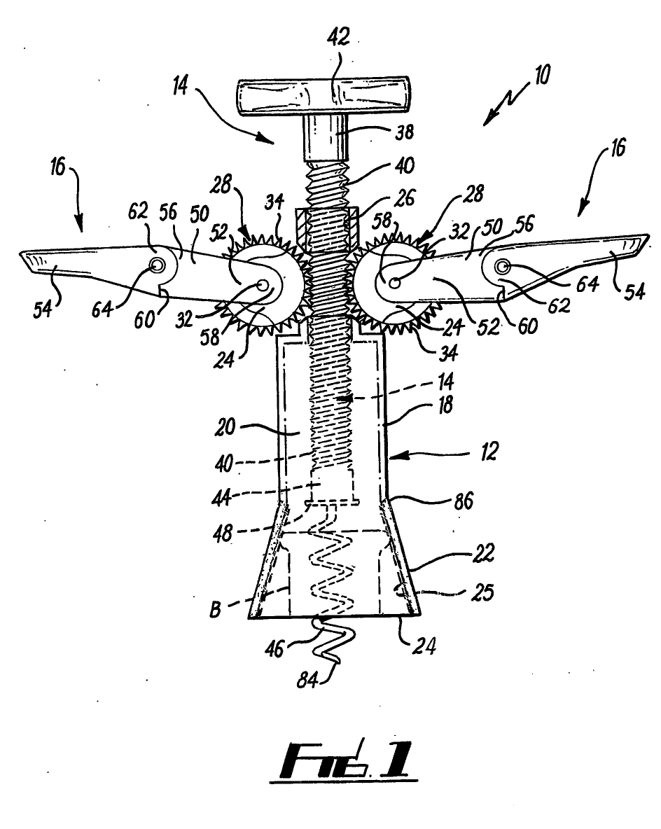

FIG. 1 is an illustration of a stopper removing device according to the present invention;

FIG. 2 shows stopper means of the device of FIG. 1;

FIG. 3 is a view of the stopper means of FIG. 2 in the direction of arrow III;

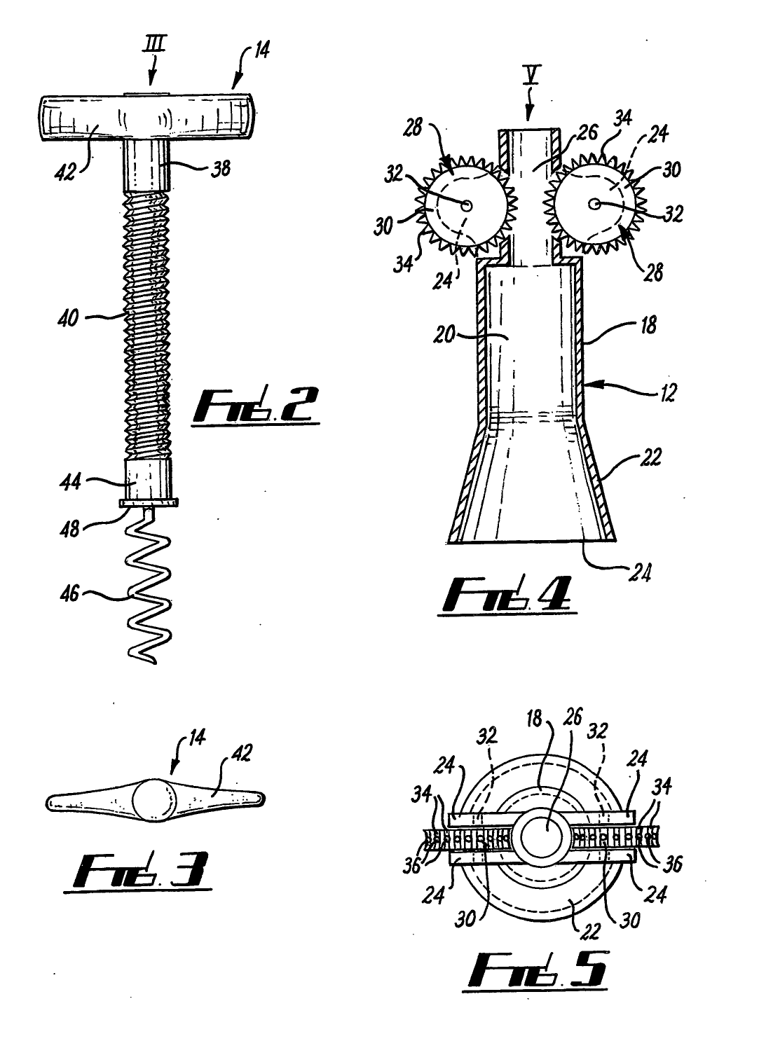

FIG. 4 shows a body and transmission means of the device of FIG. 1;

FIG. 5 is a view in the direction of arrow V in FIG. 4;

FIG. 6 is a view of handle means of the device of FIG. 1;

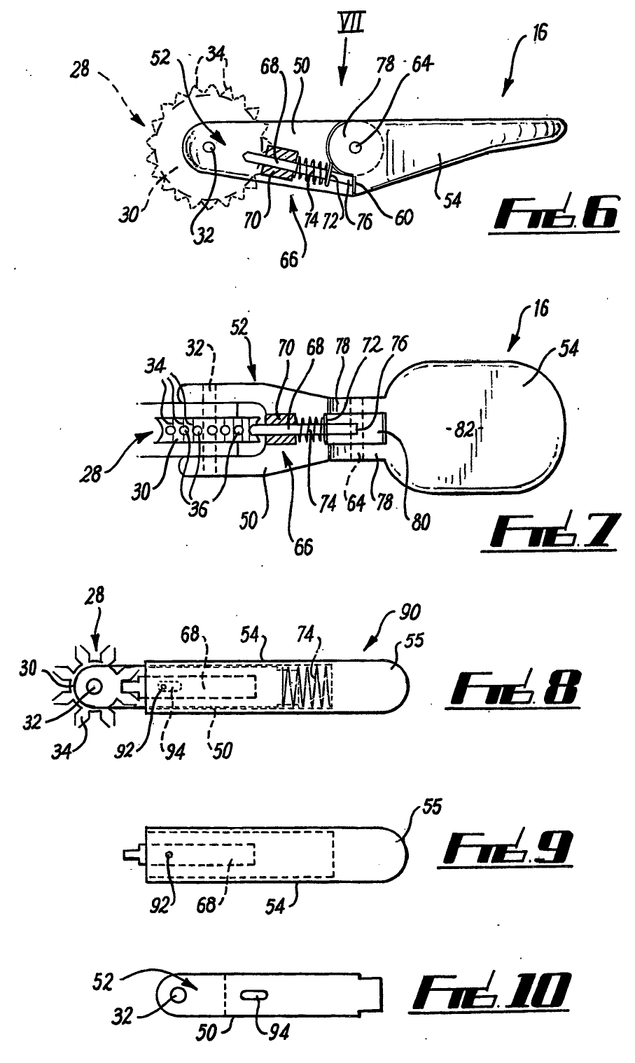

FIG. 7 is a view of the handle means of FIG. 5 in the direction of arrow VII;

FIG. 8 is a view of an alternative handle means; and

FIGS. 9 and 10 are views of parts of the handle means of FIG. 8.

Referring to the drawings, and in particular FIG. 1, there is provided a stopper removing device 10 for removing stoppers, such as corks from bottles.

The device 10 comprises a body 12, stopper means 14 to engage a stopper (not shown) to be removed and handle means 16 on the body 12 and selectively engagable with the stopper means 14 to enable selective movement of the stopper means 14 therewith relative to the body 12 and thereby removal of the stopper.

In more detail, the generally cylindrical body 12 comprises a cylindrical portion 18 defining a passage 20. The passage 20 gradually widens at one end to define a substantially frustoconical portion 22 which opens at its widest end 24. The frustoconical portion 22 includes cutting means in the form of an abrasive surface 25 around its inner surface which comprises an adhesive layer, such as PERMABOND (Registered Trade Mark), with abrasive particles located therein.

On the other end of the cylindrical portion 18 are provided two pairs of mounting flanges 24 to which the handle means 16 are located (as described later). The body 12 also defines generally between the two pairs of flanges 24 a narrower cylindrical passage 26 which is generally concentric with the passage 20. Opposing openings are provided in the sides of the passage 26 from generally between the respective pairs of flanges 24 through which transmission means 28 are operable as will be described.

Transmission means 28 are provided to transmit selective movement of the handle means 16 to cause said selective movement of the stopper means 14. Each transmission means 28 comprises a wheel 30 located between a respective pair of flanges 24 to be pivotally mounted thereon about a respective axis 32. The transmission wheels 30 are generally similar, each having a series of teeth 34 extending around an outer circumferential surface thereof. A series of holes 36 (FIG. 5) is also provided, generally between the teeth 34 and around the circumference of each wheel 30. The teeth 34 and holes 36 are generally equispaced around the transmission wheels 30.

The stopper means 14 comprises a shaft 38 along the majority of the length of which is provided a coarse external thread 40. The teeth 34 are in co-operable engagement with the external thread 40, through the said openings. At one end of the shaft is located a turning head or handle 42 and extending from the other end 44 extends a screw portion 46 which in use locates within a stopper to be removed, as will be described. A stop 48 is provided at the base of the screw portion 46 to limit the length of the stop means 14 that can be driven into a stopper or cork.

Handle means 16 is provided on each side of the device 10 operable with each transmission means 28. Each handle means 16 comprises a first section 50 which comprises two mounting portions 52 which embrace the respective flanges 24 to be mounted thereon via the pivotal axis 32. Each handle means 16 also comprises a selectively moveable section 54 pivotally mounted at the end 56 of the mounting section 52 generally opposite the end 58 at which the section 50 is mounted to the flanges 24. An abutment surface 60 is provided generally at the end 62 of each moveable section 54 at which they are pivotally attached about the pivot 64.

Referring to FIG. 6 an engagement arrangement 66 is provided on each handle means 16. The engagement arrangement 66 comprises a locating pin 68 located in a bush 70 mounted inside the mounting section 52. A retaining formation 72 is provided on the locating pin 68 and a spring 74 is operably located between the bush 70 and the retaining formation 72, such that the spring 74 acts to urge the locating pin 68 away from engagement with the transmission means 28 as will be explained.

The locating pin 68 is orientated within the mounting portion 52 to be linearly moveable between an engaging condition in which the locating pin 68 engages the transmission means 28 by locating into one of the holes 36 in the respective transmission wheel 30, and a disengaged condition in which the spring 74 urges the locating pin 68 away from location within a hole 36.

Selective pivotal movement of the moveable section 54 provides for selective movement of the engagement arrangement 66 between the engaged and disengaged conditions. In the engaged condition, the abutment surface 60 presses against the end 76 of the locating pin 68 to hold the locating pin 68 against the resilience of the spring 74 and thereby hold the pin 68 in location within a hole 36 and thereby in engagement with the stopper means 14. Selective pivotal movement of the moveable section 54 away from abutment with the locating pins 68 allows the spring 74 to urge the locating pin 68 away from engagement.

The moveable section 54 comprises two generally parallel hinge portions 78 which locate around a portion 80 of the mounting section 52 to be pivotally mounted thereon. The moveable section 54 is enlarged to provide a surface area 82 to facilitate manipulation thereof by a user.

FIGS. 8 to 10 show an alternative handle means 90 in which the same reference numerals are used to refer to like components shown in FIGS. 1 to 7. In the alternative handle means 90, the first section 50 and the selectively movable section 54, which has an end closure 55, are both substantially cylindrical and hollow. The movable section 54 is slidably mounted on the first section 50 with the first section 50 substantially located within the movable section 54. A transverse mounting pin 92 is provided to mount the locating pin 68 with respect to the movable section 54. A slot 94 is provided in the first section 50 to accommodate the mounting pin 92 and thereby enable the selectively movable section 54 to slide over the first section 50, with the locating pin 68 accommodated inside the first section 50. A spring 74 is operably located between the first section 50 and the movable section 54, such that the spring acts to urge the movable section 54 and the first section 50 apart and thereby urge the locating pin 68 away from enagagement with the transmission means 28. In this embodiment, in the engaged condition the locating pin 68 engages between the teeth 34 of the transmission wheel 30, as best seen in FIG. 8.

The device 10 is intended for use in removing corks or cork equivalents from bottles of wine. It will however be appreciated that it falls within the scope of the present invention for the device to be operable to remove other types of stoppers from containers or bodies.

In use, the device 10 is offered up to the neck of a bottle B (FIG. 1) with the stopper means 14 withdrawn into the body 12 in the direction away from the end 24 such that the tip 84 of the screw portion is located generally behind the region 86 of the body 12 where the passage starts to enlarge into the frustoconical portion 22. The frustoconical portion 22 is then located over the neck of a bottle B such that the neck of the bottle B and the body 12 are generally concentric and the cutting means 25 engages protective plastics packaging material (not shown) which may be provided on the neck of the bottle.

Prior to removing the stopper, it is preferable to remove the plastics packaging if present. Thus, with the device 10 held in position around the neck of the bottle B, the body 12 of the device 10 is twisted whilst the bottle B is held stationary, thereby causing the cutting means 25 to cut the plastics material. The plastics material may then be removed by hand and discarded.

The device 10 is then again offered up to the bottle B such that the neck of the bottle B and the body 12 are generally concentric and, with the device 10 held in this position, the stop means 14 is threadably moved toward the stopper in the bottle B. As the screw portion 46 encounters the stopper, continued twisting of the stopper means 14 using the turning head 42 drives the screw portion 46 into the stopper within the bottle B, until the stop 48 abuts against the top of the stopper. As mentioned above, the overall length of the screw portion 46 is such that when the stop 48 abuts the cork, the screw portion 46 is still wholly located within the cork or stopper, thereby preventing any possibility of contamination caused by the screw portion 46 passing straight through the cork into the bottle B.

Usually, although not essentially, the handle means 16 will be in the first condition on the screw portion 40 and driven into the stopper, such that as the stop means 14 is threaded downward into the stopper the teeth 34 with the thread 40 causes the transmission wheels 30 to rotate and thereby pivotal movement of the handle means 16 about the pivot axis 32 causing the handle means 16 to rise upward, i.e. generally away from the bottle B.

When the screw portion 46 is located within the cork or stopper as described above and the handle means 16 in the aforesaid risen position, a user can then take hold of the handles 16 desirably about the moveable section 54.

Holding the moveable section 54 in the first position, i.e. with the locating pins located in respective holes in the respective transmission wheel 30 the user can then urge the handles 16 downward to lie generally alongside the body 12. This action draws the stopper means 14 back into the body 12 thereby lifting the cork or stopper from within the neck of the bottle B.

Often it is found that the distance the stopper means 15 is drawn back into the body 12 is less than the length of the stopper being withdrawn, which means that at this stage the stopper will remain located in the bottle B.

In this situation, a user pivots the moveable sections 54 way from the first position in a generally upward direction to cause the abutment surface 60 to move away from location with the end 76 of the locating pins 68 thereby allowing the spring 74 to urge the locating pin away from location within the transmission wheel 30 thereby disengaging the handle means 16.

A user then pivots the handle means 16 about the pivots 32 in a generally upward direction.

Once the handle means 16 have both been moved upward by the desired amount, which would usually be to the maximum height, a user returns the moveable sections 54 back to the first position. As the user moves the moveable sections 54 back to the first position, the abutment surfaces 60 locate against the ends of the respective locating pin 68 and gradually move the locating pins against the resilience of the spring 74 back into location with a hole in a respective transmission wheel 30. A user then urges the handle means 16 downward in the first condition thereby causing further linear movement of the stopper means 14 and further withdrawal of the stopper from the bottle.

It will be appreciated that this movement can be repeated as many times as necessary to remove the stopper.

If the device 10 includes the alternative handle means 90 of FIGS. 8 to 10, then the above procedure is adapted accordingly. In particular, it should be noted that the handle means 90 will usually be in the disengaged condition on the screw portion 40, and will not therefore rise upwards as the stopper means 14 is threaded down into the stopper. In this case, it will be necessary to manually move the handle means 90 in the upward direction.

In order to move the handle means 90 into the engaged condition—i.e. with the locating pins 60 located between respective teeth 34 on the transmission wheels 30—a user must slide the movable section 54 over the first section 50 against the biasing action of the spring 74. When it is desired to disengage the handle means 90 from the transmission means 28, a user can simply release the force exerted on the movable section 54 thereby enabling it, under the biasing action of the spring 74, to slide over the first section 50 in a direction away from the transmission means 28 and thereby resulting in the disengagement of the locating pin 68 from the transmission means 28.

It will be appreciated that the device 10 therefore provides for a stopper removing device which only has to be driven into a stopper once and to a sufficient degree to provide for suitably secure location and engagement with the stopper. This mitigates the likelihood of a user driving the device completely through the cork thereby contaminating the contents of the bottle.

Of course, the length of the screw portion 46 is predetermined for use with predetermined lengths of stopper. It is within the scope of the present invention to vary the length of the screw portions 46 to accommodate different lengths of stopper.

Various modifications may be made without departing from the spirit or scope of the present invention. For example, the cutting means may comprise one or more blades equispaced around the inner surface of the frustoconical portion.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-48. (canceled)

49. A stopper removing device for removing a stopper from a container or similar, the device comprising a body, stopper means to engage a stopper to be removed and handle means on the body, the handle means being selectively engageable with the stopper means to enable selective movement of the stopper means therewith relative to the body.

50. A device according to claim 49, wherein transmission means are provided to transmit selective movement of the handle means to said movement of the stopper means.

51. A device according to claim 50, wherein the transmission means is located between the handle means and stopper means.

52. A device according to claim 50, wherein the transmission means is in co-operation with the stopper means, desirably permanently.

53. A device according to claim 50, wherein the transmission means is mounted on the body and provides for transmission of generally pivotal movement of the handle means to substantially linear movement of the stopper means.

54. A device according to claim 53, wherein the transmission means is pivotally mounted on the body.

55. A device according to claim 49, wherein the handle means is mounted on the body.

56. A device according to claim 55, wherein the handle means is pivotally mounted on the body.

57. A device according to claim 50, wherein the handle means is selectively moveable between a first condition in which the handle means is operably engaged with the transmission means and said selective movement of the handle means causes movement of the transmission means and a second condition in which the handle means is disengaged therefrom.

58. A device according to claim 50, wherein the handle means comprises an engagement arrangement having an engagement member and resilient means to urge the engagement member away from operable engagement with the transmission means.

59. A device according to claim 58, wherein the resilient means comprises a spring to urge the engagement member.

60. A device according to claim 58, wherein the engagement member is in the form of a locating pin.

61. A device according to claim 58, wherein the handle means comprises a moveable section selectively moveable against the resilient means to a first position wherein the engagement member is in engagement with the transmission means.

62. A device according to claim 61, wherein the handle means is further selectively moveable to a second position to allow the resilient means to urge the engagement member away from engagement with the transmission means.

63. A device according to claim 61, wherein the moveable section is movably attached, desirably pivotally, to a further section of the handle means on which the engagement arrangement is provided.

64. A device according to claim 63, wherein the further section is preferably pivotally mounted on the body.

65. A device according to claim 61, wherein the movable section is slidably attached to a further section of the handle, the engagement arrangement being provided on the movable section.

66. A device according to claim 65, wherein the further section is pivotally mounted on the body and is substantially located within the movable section to enable sliding movement of the movable section over the further section.

67. A device according to claim 65, wherein the engagement member is in the form of a locating pin provided on the movable section.

68. A device according to claim 50, wherein the transmission means comprises a wheel member rotatably attached to the body.

69. A device according to claim 68, wherein the wheel member comprises an engagement formation co-operable with formations provided on the stopper means, whereby to provide rotational movement of the transmission means to cause generally linear movement of the stopper means.

70. A device according to claim 69, wherein a plurality of engagement formations are provided around the transmission means.

71. A device according to claim 70, wherein the plurality of engagement formations comprise a series of teeth.

72. A device according to claim 50, wherein a series of holes or similar formations is provided around the transmission means.

73. A device according to claim 72, wherein the series of holes is provided around an outer circumferential perimeter of the transmission means to individually receive the engagement member during use.

74. A device according to claim 72, wherein the holes or similar formations are equispaced around the transmission means.

75. A device according to claim 71, wherein the engagement member is individually received between the teeth around the transmission means during use.

76. A device according to claim 49, wherein the stopper means is located through and generally within the body.

77. A device according to claim 49, wherein the body comprises locating means on one end thereof to locate against a container or other body from which a stopper is to be removed.

78. A device according to claim 49, wherein the stopper means comprises a stopper engaging portion which may be twistedly locatable into a stopper to be removed.

79. A device according to claim 78, wherein a stop means is provided to limit the distance the engaging portion can be inserted into a stopper.

80. A device according to claim 49, wherein the stopper means comprises a handle to facilitate twisting of the stopper means for location in the stopper.

81. A device according to claim 78, wherein the said formations on the stopper means are located between the handle and the stopper engaging means.

82. A device according to claim 49, wherein the body is generally cylindrical and includes a substantially frustoconical portion for location over a neck of a container or similar, the frustoconical portion including cutting means to enable removal of protective packaging from a container or similar.

83. A device according to claim 82, wherein the cutting means comprises an abrasive surface.

84. A device according to claim 83, wherein the abrasive surface comprises a layer of adhesive material and abrasive particles located therein.

85. A device according to claim 82, wherein the cutting means comprises one or more blades.

86. A device according to claim 85, wherein three cutting blades are provided which are equispaced around an inner surface of the frustoconical portion.

87. A device according to claim 50, wherein a plurality of transmission means and handle means is provided, to enable generally simultaneous actuation of transmission means to remove a stopper from a container.

88. A device according to claim 87, wherein a pair of transmission means and handle means is provided.

89. A stopper removing device for removing a stopper from a container or similar, the device comprising a body, stopper means to engage a stopper to be removed and handle means on the body, the body including cutting means to enable removal of protective packaging from a container or similar.

90. A device according to claim 89, wherein the body comprises a substantially frustoconical portion for location over a neck of the container or similar, and the frustoconical portion including the cutting means.

91. A device according to claim 89, wherein the cutting means comprises an abrasive surface.

92. A device according to claim 91, wherein the abrasive surface comprises a layer of adhesive material and abrasive particles located therein.

93. A device according to claim 89, wherein the cutting means comprises one or more blades.

94. A device according to claim 93, wherein three cutting blades are provided which are equispaced around an inner surface of the frustoconical portion.
